(19) United States
(12) Patent Application Publication
(10) Pub. No.: US 2023/0234309 A1
(43) Pub. Date: Jul. 27, 2023

(54) REPAIR PATCH FOR AN ELASTOMER COMPONENT WITH AN IMPROVED CONNECTION LAYER

(71) Applicant: REMA TIP TOP AG, Poing (DE)

(72) Inventors: Christian CASPER, Markt Indersdorf (DE); Florian KINZL, Pliening (DE); Sylvia MÜCKE, Wörth (DE)

(21) Appl. No.: 17/925,195

(22) PCT Filed: May 3, 2021
(86) PCT No.: PCT/EP2021/061586

§ 371 Date: Nov. 14, 2022

(30) Foreign Application Priority Data
Jun. 9, 2020 (DE) 10 2020 207 204.3

(51) Int. Cl. B29C 73/10

(52) U.S. Cl. CPC B29C 73/10; B29K 2995/0088; B29L 2030/00

(57) ABSTRACT

A repair patch for an elastomeric element, particularly for a vehicle tire, use thereof and method for bonding a repair patch to an elastomeric element. The repair patch (1) comprises: a top layer (10), a bonding layer (30) for covering a wall (80) of the elastomeric element (40), and at least one intermediate layer (20) arranged between the bonding layer (30) and the top layer (10), wherein prior to vulcanization with the elastomeric element (40), the bonding layer (30) has a first and a second natural rubber component, wherein the first natural rubber component has a lower molecular weight Mw than the second natural rubber component, such that a mixture of the first and second natural rubber components has a bimodal molecular weight distribution.

### TECHNICAL FIELD

The invention relates to a repair patch for an elastomeric element, particularly for a vehicle tire, to the use of the repair patch for repairing a damaged vehicle tire, and to a method for bonding the repair patch to an elastomeric element. In particular, prior to vulcanization, the repair patch comprises a bonding layer having a mixture of a first and a second natural rubber component, wherein the mixture has a bimodal molecular weight distribution.

### TECHNICAL BACKGROUND

In general, the repair of a damaged vehicle tire is carried out in the case of minor punctures on the surface area by means of a so-called combo repair body. In the case of larger damages in the circumferential or sidewall area, on the other hand, the damaged area is repaired and the so-called funnel resulting from this procedure is filled with raw rubber. The reinforcing members interrupted in the damaged area are then covered by means of a repair patch, which in turn contains corresponding reinforcing members. Since the power flow in the reinforcing members of vehicle tires and repair patches must be transmitted via the rubber layers in between, high demands are placed in particular on the bonding layer between the vehicle tire and the repair patch with regard to a secure and permanent bond to the vehicle tire.

In the methods known for bonding a repair patch on a vehicle tire, two elements are required to create a permanent bond between the repair patch and the vehicle tire, an adhesive and the above-mentioned bonding layer of the repair patch.

The adhesive usually consists of natural rubber dissolved in solvent, resins and accelerators needed for the reaction, especially for vulcanization.

In known vehicle tire repair methods, the repair patch is usually cleaned and roughened before application to create an active surface with high structure. The next step is to apply the adhesive to the repair area. The solvent of the adhesive must then be allowed to evaporate. Then the repair patch is placed on the repair area and is pressed onto the repair area. Depending on the selected method, the vulcanization is then carried out without pressure at room temperature or by applying pressure and temperature using suitable equipment (e.g., in an autoclave or in a heating press). The main disadvantage of this process is the time required for the solvent to evaporate.

In general, the known adhesives are based on organic solvents, which can pose a risk to the environment and the health of the user. In various countries, some of these solvents may therefore no longer be used to repair rubber components.

Furthermore, the evaporation of the solvent is demanding because the adhesion of the repair patch is strongly dependent on the degree of evaporation. If the adhesive has dried for too long, sufficient adhesion is no longer achievable (overdrying). If, on the other hand, the drying or evaporation time is too short, there is still too much solvent on the repair area, so that even then the adhesion of the repair patch is not guaranteed, because the solvent remaining in the repair area leads to formation of bubbles, especially in the case of temperature vulcanization. When using flammable solvents, additional measures are necessary to prevent fires, e.g., by means of vacuuming and ventilation.

The bonding layer of a repair patch is usually made of masticated natural rubber and resins and does not contain accelerators. The properties of conventional bonding layers are usually sufficient for standard applications. However, developments in the field of elastomeric elements, especially in the field of vehicle tires, will of course also influence the requirements that will be applied to a repair patch in the future. For example, the tire casing or even the roughened structure of the damaged area during repair can differ greatly depending on the manufacturer or area of application.

It is therefore the task of the invention to provide a repair patch and a method for bonding the repair patch to an elastomeric element, which make it possible to variably adjust the properties of the bonding layer, in particular an adhesive strength and an intensity of load, depending on an application.

### Solution of the Problem

The problem is solved according to the features of independent claims 1 and 15. The dependent claims are directed to particular embodiments of the invention.

According to the invention, a repair patch for an elastomeric element, particularly for a vehicle tire, comprises a top layer, a bonding layer for covering a wall of the elastomeric element, and at least one intermediate layer disposed between the bonding layer and the top layer.

According to the invention, prior to vulcanization with the elastomeric element, the bonding layer has a first and a second natural rubber component, wherein the first natural rubber component has a lower molecular weight Mw than the second natural rubber component, such that a mixture of the first and second natural rubber components has a bimodal molecular weight distribution. Thus, an adhesive strength of the bonding layer may be advantageously adjusted by means of the first natural rubber component and an intensity of load of the bonding layer via the second natural rubber component.

In this context, bimodal means a distribution that has two modes or maxima. A bimodal distribution may be both symmetrical and asymmetrical. According to the invention, the bimodal molecular weight distribution (molar mass distribution) results from the proportional superposition of the two, respectively unimodal (one mode, one maximum) molecular weight distributions of the first and second natural rubber components. Thereby, the maximum of the unimodal molecular weight distribution of the first natural rubber component is at a lower molecular weight than that of the second natural rubber component. In other words, according to the invention, the first natural rubber component has a maximum in the unimodal molecular weight distribution which is at a lower molecular weight than that of the second natural rubber component.

The values given herein refer to the so-called mass average Mw. The bimodal molecular weight distribution is thus described accordingly by the distribution of weight proportion depending on the molecular weight.

According to the invention, natural rubbers are used in the bonding layer. Structurally, natural rubber is a cis-1,4-polyisoprene, which is formed by polymerization of isoprene monomers:

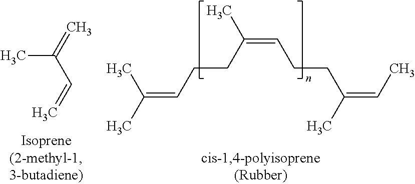

Natural rubbers belong to the group of so-called elastomers. Elastomers are wide-meshed polymers that exhibit rubber-elastic behavior. Elastomers may be cross-linked directly during polymerization or later by vulcanization.

In a preferred embodiment, the first natural rubber component has a molecular weight of Mw=1×10⁶ g/mol. In a further preferred embodiment, the second natural rubber component has a molecular weight of Mw=2×10⁶ g/mol. In both embodiments the molecular weight may be determined by diffusion-sedimentation and/or osmosis. In particular, according to the invention, commercially available products with corresponding molecular weights may be used. For example, as the first natural rubber component, commercially available natural rubber with constant low viscosity may be used, which is generally produced by cutting rubber sap from trees to form latices, precipitating with acid to form rubber crumbs and pressing to form bales. For example, natural rubber of constant high viscosity, such as RSS1 or RSS3 type, may be used as the second natural rubber component.

Since natural rubber as a natural product contains insoluble gel components, the molecular weight of natural rubber is often difficult to determine. Alternatively, or additionally, the so-called Mooney viscosity may be used for characterization. In this case, two polymers of the same type whose Mooney viscosities are clearly different can also be clearly distinguished in molecular weight. In a preferred embodiment, a Mooney viscosity of the first natural rubber component and the second natural rubber component may therefore differ by at least a factor of 2. In a particularly preferred embodiment, the Mooney viscosity ML=1+4/100° C. of the first natural rubber component may be 35-40 MU. In a further preferred embodiment, the Mooney viscosity ML=1+4/100° C. of the second natural rubber component may be 70-90 MU. The Mooney viscosity may be determined, for example, according to DIN 53523.

According to the invention, it is not of any significance whether the first and/or the second natural rubber component is a single natural rubber or a mixture of natural rubbers, wherein the molecular weight Mw, in each case, is in the low or high range, respectively. However, in a preferred embodiment, the first natural rubber component and/or the second natural rubber component may comprise a mixture of natural rubbers. In a further preferred embodiment, the first natural rubber component and/or the second natural rubber component may comprise a single natural rubber.

According to the invention, the proportion of the first and second natural rubber components in the mixture is not limited. In a preferred embodiment, a proportion of the first natural rubber component may be 25-50 wt % based on the total mass of the first and second natural rubber components, and a proportion of the second natural rubber component may be 50-75 wt. % based on the total mass of the first and second natural rubber components. Particularly preferably, the proportion of the first natural rubber component may be 35-45 wt. % and the proportion of the second natural rubber component may be 55-65 wt. %. Even further preferably, the proportion of the first natural rubber component may be 44 wt. % and the proportion of the second natural rubber component may be 56 wt. %. Thus, a good adhesive strength and an improved intensity of load may be advantageously ensured at the same time.

Furthermore, in a preferred embodiment, the bonding layer may additionally comprise a filler system of a precipitated silica 5-15%, a silica 20-30% and a colourant. Furthermore, in another preferred embodiment, the bonding layer may comprise at least 2% sulfur. The proportions correspond in each case to wt. % based on the total mass of the bonding layer. During vulcanization, Sulfur may, for example, cross-link the first and second natural rubber components:

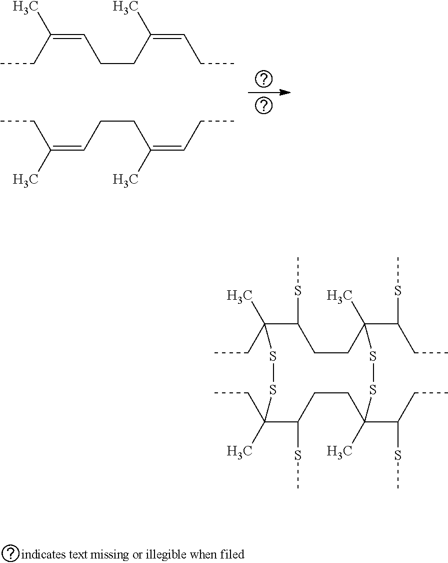

In a further preferred embodiment, a removable protective film may also be provided to protect the bonding layer from contamination until it is used.

In a further preferred embodiment, the intermediate layer may comprise a plurality of fibrous inserts arranged in a substantially structured manner.

According to the invention, the repair patch described above may be used to repair a damaged vehicle tire.

According to the invention, a method for bonding the above-described repair patch to an elastomeric element comprises the step of preparing a bonding layer comprising first and second natural rubber components, wherein the first natural rubber component has a lower molecular weight Mw than the second natural rubber component, in such a way that a mixture of the first and second natural rubber components has a bimodal molecular weight distribution. According to the invention, the bonding layer is prepared by: (a) homogenizing the second natural rubber component in an internal mixer, (b) re-extracting the second natural rubber component, and (c) mixing the first and homogenized second natural rubber components. The method according to the invention further comprises the step of providing the elastomeric element; the step of applying the repair patch to the elastomeric element over the bonding layer, in particular at a repair area; and the step of vulcanizing the repair patch to the elastomeric element.

In a preferred embodiment, in step c) of manufacturing the bonding layer, the first and the homogenized second natural rubber components may additionally be mixed with at least 2% sulfur, and a filler system comprising a precipitated silica 5-15%, a silica 20-30% and a colourant.

### BRIEF DESCRIPTION OF THE FIGURES

FIG. 1 schematically illustrates a sectional view of a repair patch for a vehicle tire according to an embodiment.

FIG. 2 schematically illustrates a bimodal molecular weight distribution resulting from the superposition of two unimodal molecular weight distributions of a first and a second natural rubber component.

FIG. 3 illustrates a block diagram of a portion of a method for bonding a repair patch to an elastomeric element according to an embodiment.

FIG. 4 illustrates a bar diagram of the different adhesive strengths of a bonding layer with natural rubber in unimodal and bimodal molecular weight distribution.

FIG. 5 illustrates a bar diagram relating to the structural resistance of a bonding layer with natural rubber in unimodal and bimodal molecular weight distribution.

### DETAILED DESCRIPTION OF THE FIGURES AND PREFERRED EMBODIMENTS

Examples or embodiments of the present invention are schematically described below with reference to the accompanying figures. It is noted, however, that the present invention is in no way limited or restricted to the examples of embodiments and their features described below, but further encompasses modifications of the examples of embodiments, in particular those encompassed by modification of the features of the examples described or by combination of individual or multiple features of the examples described within the scope of protection of the claims.

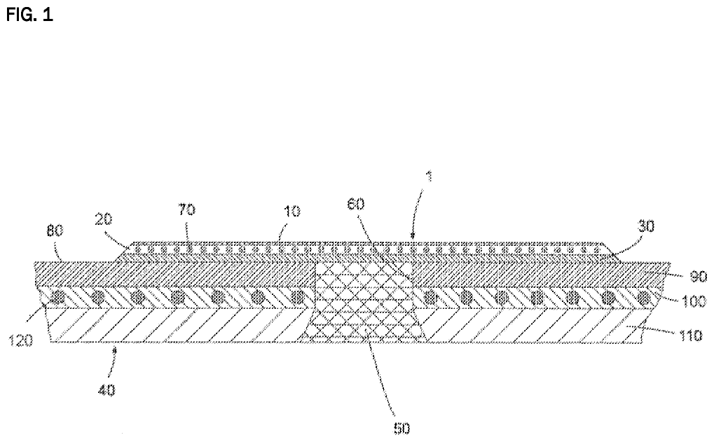

With reference to FIG. 1, a repair patch 1 for vehicle tires according to the present invention is schematically illustrated. A top layer 10 is formed on the upper surface of the repair patch 1, which has no ready-made tack before and after repair. An intermediate layer 20 is formed adjacent to the top layer 10. In a preferred embodiment, the intermediate layer 20 may comprise a plurality of fibrous inserts 70. These inserts 70 may be arranged in one or more layers across the thickness of the intermediate layer 20, and each individual layer may have a structural arrangement of the fibrous inserts 70. The orientation of the individual layers in the intermediate layer 20 may be different from each other. Particularly, in the case of major damage in the tread or sidewall area, these inserts 70 may serve to bridge the reinforcing members interrupted in the damage area.

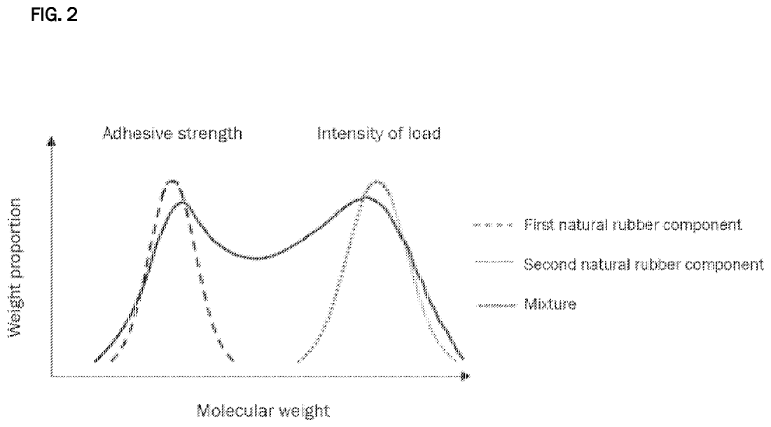

The bonding layer 30 is formed underneath the repair patch 1, which is in contact with the wall 80 of the vehicle tire during and after the repair. Furthermore, the bonding layer 30 is in contact with a raw rubber composition 50 before and after vulcanization of the vehicle tire. The bonding layer 30 and its specific properties are described in detail below with reference to FIG. 2.

As part of the repair of the damaged vehicle tire, the damaged area of the vehicle tire is roughened to remove dust and dirt and to expose an undamaged layer of components contained within the vehicle tire, forming a substantially conical shape for a repair area 60 in the vehicle tire. The repair area 60 is then filled with the raw rubber composition 50 prior to vulcanization of the bonding layer 30.

The repair patch 1 is then placed on the repair area 60, the dimensions of which are chosen so that the repair area 60 is completely covered by it. Furthermore, the dimensions of the repair patch 1 should be chosen such that the tire wall 80 is sufficiently covered by the bonding layer 30 for a stable bond. The repair patch 1 may, for example, be preheated to an appropriate joining temperature.

After the repair patch 1 has been applied to the tire, the repair area 60 and the repair patch 1 are vulcanized under pressure and temperature by means of a suitable device or in an autoclave.

In a preferred embodiment, a removable protective film may also be provided to protect the bonding layer 30 from contamination until it is used.

The structure of the vehicle tire is shown as an example for the sidewall region of a radial truck tire in such a way that the wall 80 of the vehicle tire is formed by the inner liner 90, the carcass 100 adjoining the inner liner and having the cord 120 in the form of an insert. Adjacent to the carcass 100 is the sidewall rubber 110 of vehicle tire.

Referring to FIG. 2, a bimodal molecular weight distribution (solid line) is schematically shown from the superposition of two unimodal molecular weight distributions for a first (dashed line) and a second (dotted line) natural rubber component respectively. As shown in FIG. 2, the first natural rubber component has a lower molecular weight Mw than the second natural rubber component, as indicated by the position of the maximum. Both the first and the second natural rubber components have a unimodal molecular weight distribution. This results from the fact that natural rubber generally always has a certain molecular weight distribution, wherein the width of the curve may be an indicator of the purity or quality of the natural rubber.

If the first and second natural rubber components are now mixed together, the bimodal molecular weight distribution results from the superposition of the two unimodal molecular weight distributions corresponding to the mixing proportions. The position of the two maxima in the bimodal molecular weight distribution is also determined by the difference of the maxima of the unimodal molecular weight distributions. If, for example, the maxima of the two unimodal molecular weight distributions are close to each other, i.e., if the first and second natural rubber components have molecular weights that are close to each other, this is also reflected in the bimodal distribution. The same applies in the reverse case. According to the invention, a bimodal molecular weight distribution is thus bimodal as long as two maxima may be identified. However, in a preferred embodiment, the first natural rubber component may have a molecular weight of Mw=1×10⁶ g/mol. In a further preferred embodiment, the second natural rubber component may have a molecular weight of Mw=2×10⁶ g/mol. In both embodiments, the molecular weight may be determined by diffusion sedimentation and/or osmosis.

Since natural rubber as a natural product contains insoluble gel components, the molecular weight of natural rubber is often difficult to determine. Alternatively, or additionally, the so-called Mooney viscosity may therefore be used for characterization. In a preferred embodiment, a Mooney viscosity of the first natural rubber component and the second natural rubber component may therefore differ by at least a factor of 2. In a particularly preferred embodiment, the Mooney viscosity ML=1+4/100° C. of the first natural rubber component may be 35 to 40 MU. In a further preferred embodiment, the Mooney viscosity ML=1+4/100° C. of the second natural rubber component may be 70 to 90 MU. The Mooney viscosity may be determined according to DIN 53523, for example.

As also shown in FIG. 2, the bonding layer's adhesive strength may be adjusted via the proportion of the first natural rubber component and the intensity of load via the second natural rubber component. According to the invention, the proportion of the first and second natural rubber components in the mixture is not limited. However, in a preferred embodiment, a proportion of the first natural rubber component may be 25 to 50 wt % based on the total mass of the first and second natural rubber components, and a proportion of the second natural rubber component may be 50 to 75% wt % based on the total mass of the first and second natural rubber components. Particularly preferably the proportion of the first natural rubber component may be 35 to 45 wt % and the proportion of the second natural rubber component may be 55 to 65 wt %. Even further particularly preferably the proportion of the first natural rubber component may be 44 wt % and the proportion of the second natural rubber component may be 56 wt %. Advantageously, however, greater importance is attached to the adhesive strength, so that the proportion of the first natural rubber component is selected so that the adhesive strength is high even with improved intensity of load.

According to the invention, it is not of any significance whether the first and/or the second natural rubber component is a single natural rubber or a mixture of natural rubbers. As mentioned above, natural rubber, considered as a single component, will generally always already have a certain molecular weight distribution. However, this is equally true for mixtures of two or more individual natural rubbers, which may be prepared to have a corresponding unimodal molecular weight distribution. In a preferred embodiment, therefore, the first natural rubber component and/or the second natural rubber component may comprise a mixture of natural rubbers. In another preferred embodiment, the first natural rubber component and/or the second natural rubber component may comprise a single natural rubber.

Furthermore, in a preferred embodiment, the bonding layer 30 may additionally comprise, in addition to the first natural rubber component and the second natural rubber component, a filler system of a precipitated silica 5 to 15%, a silica 20 to 30% and a colourant.

Furthermore, in another preferred embodiment, the bonding layer may contain at least 2% sulfur. During vulcanization, the first and second natural rubber components may thus be cross-linked via sulfur bridges.

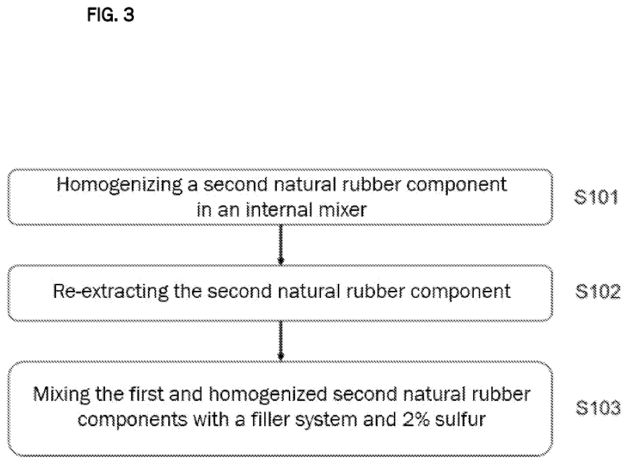

With reference to FIG. 3, a portion of a method for bonding a repair patch to an elastomeric element according to an embodiment is described below. As shown in FIG. 3, in order to produce a bonding layer comprising a first and a second natural rubber component, wherein the first natural rubber component has a lower molecular weight Mw than the second natural rubber component, in such a way a mixture of the first and the second natural rubber component has a bimodal molecular weight distribution, the second natural rubber component is first homogenized in an internal mixer in step S101. After homogenization, the second natural rubber component is removed from the internal mixer again in step S102. The now homogenized second natural rubber component is then mixed with the first natural rubber component. According to the embodiment shown in FIG. 3, in step S103 the homogenized second natural rubber component may be mixed with the first natural rubber component, the filler system described above and at least 2% sulfur.

The steps described with reference to FIG. 3 are part of the process according to the invention, which further comprises the following steps: Providing an elastomeric element; applying the repair patch to the elastomeric element over the bonding layer, in particular at a repair area; and vulcanizing the repair patch to the elastomeric element.

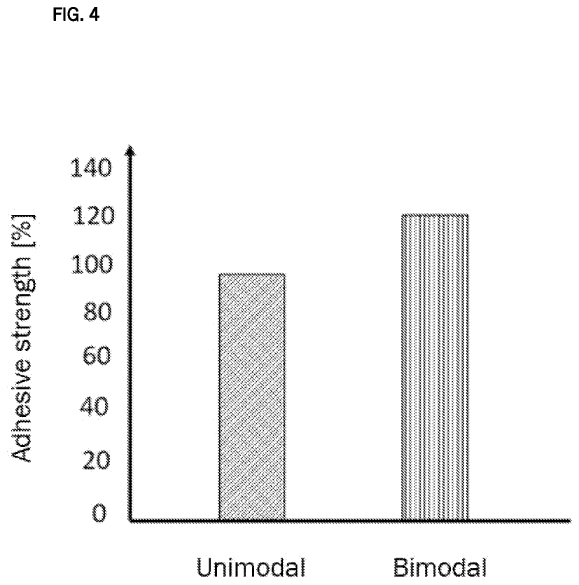

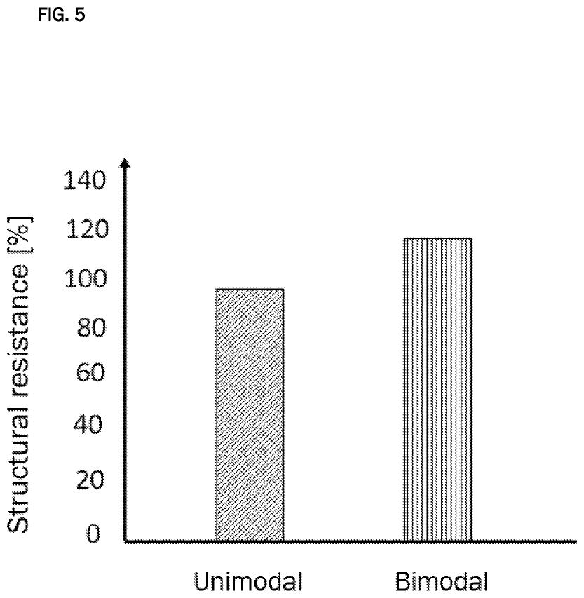

The advantages of the present invention will now be explained with reference to FIGS. 4 and 5. In particular, the repair patch and method described herein allow the properties of the bonding layer to be tailored based on the bimodal molecular weight distribution of the two natural rubber components with respect to the compatibility of the repair patch with different tire casings or different roughened structures of damaged areas. As may be seen from FIGS. 4 and 5, the mixture of the first and second natural rubber components with bimodal molecular weight distribution not only exhibits improved adhesive strength compared to a respective unimodal distribution in the natural rubber component, but also simultaneously exhibits improved structural resistance. In other words, a bonding layer having a bimodal molecular weight distribution by mixing a first and a second natural rubber component shows an improved ability to bond to roughened surfaces due to the proportion of low molecular weight natural rubber, whereas due to the proportion of high molecular weight natural rubber, an increased structural resistance of the bonding layer may be achieved, resulting in improved durability.

### LIST OF REFERENCE SIGNS

1 repair patch
10 top layer
20 intermediate layer
30 bonding layer
40 elastomeric element
50 raw rubber composition
60 repair area
70 fibrous insert
80 wall
90 inner liner
100 carcass
110 sidewall rubber of vehicle tire
120 cord

1. A repair patch for an elastomeric element,
particularly for a vehicle tire, comprising:
a top layer,
a bonding layer for covering a wall of the elastomeric element, and
at least one intermediate layer disposed between the bonding layer and the top layer, wherein
prior to vulcanization with the elastomeric element, the bonding layer has a first and a second natural rubber component, wherein the first natural rubber component has a lower molecular weight Mw than the second natural rubber component, such that a mixture of the first and second natural rubber components has a bimodal molecular weight distribution.

2. The repair patch according claim 1, wherein a Mooney viscosity of the first natural rubber component and the second natural rubber component is different by at least a factor of 2.

3. The repair patch according to claim 2, wherein the Mooney viscosity ML=1+4/100° C. of the first natural rubber component is 35 to 40 MU.

4. The repair patch according to claim 2, wherein
the Mooney viscosity ML=1+4/100° C. of the second natural rubber component is 70 to 90 MU.

5. The repair patch according to claim 1, wherein
the first natural rubber component and/or the second natural rubber component consist of a mixture of natural rubbers.

6. The repair patch according to claim 1, wherein
the first natural rubber component and/or the second natural rubber component consist of a single natural rubber.

7. The repair patch according to claim 1, wherein
the first natural rubber component has a molecular weight of Mw=1×10⁶ g/mol, and wherein the molecular weight is determined by diffusion-sedimentation and/or osmosis.

8. The repair patch according to claim 1, wherein
the second natural rubber component has a molecular weight of Mw=2×10⁶ g/mol, and wherein the molecular weight is determined by diffusion-sedimentation and/or osmosis.

9. The repair patch according to claim 1, wherein
a proportion of the first natural rubber component is 25 to 50 wt. % based on the total mass of the first and second natural rubber components, and a proportion of the second natural rubber component is 50 to 75 wt. % based on the total mass of the first and second natural rubber components.

10. The repair patch according to claim 1, wherein
the bonding layer additionally comprises a filler system of a precipitated silica 5 to 15%, a silica 20 to 30% and a colourant.

11. The repair patch according to claim 1, wherein
the bonding layer comprises at least 2% sulfur.

12. The repair patch according to claim 1, wherein
a removable protective film is provided which protects the bonding layer from contamination until it is used.

13. The repair patch according to claim 1, wherein
the intermediate layer comprises a plurality of fibrous inserts arranged in a substantially structured manner.

14. The repair patch according to claim 1, wherein the repair patch is used for repairing a damaged vehicle tire.

15. A method for bonding a repair patch according to claim 1 to an elastomeric element, comprising the steps:
preparing a bonding layer comprising first and second natural rubber components, wherein the first natural rubber component has a lower molecular weight Mw, than the second natural rubber component, such that a mixture of the first and second natural rubber components has a bimodal molecular weight distribution, by:
(a) homogenizing the second natural rubber component in an internal mixer;
(b) re-extracting the second natural rubber component; and
(c) mixing the first and homogenized second natural rubber components;
providing the elastomeric element;
applying the repair patch to the elastomeric element over the bonding layer, in particular at a repair area; and
vulcanizing the repair patch to the elastomeric element.

16. The method according to claim 15, wherein
in step c) of manufacturing the bonding layer, the first and the homogenized second natural rubber components are additionally mixed with at least 2% sulfur, and a filler system comprising a precipitated silica 5 to 15%, a silica 20 to 30% and a colourant.
